(19) United States
(12) Patent Application Publication
(10) Pub. No.: US 2018/0102633 A1
(43) Pub. Date: Apr. 12, 2018

(54) APPARATUS AND METHOD FOR PRODUCING A POWER CHAIN

(71) Applicant: KROMBERG & SCHUBERT GMBH, Wuppertal (DE)

(72) Inventor: Stephan Fahrnbauer, Abensberg (DE)

(73) Assignee: KROMBERG & SCHUBERT GMBH, Wuppertal (DE)

(21) Appl. No.: 15/568,885

(22) PCT Filed: Apr. 5, 2016
(86) PCT No.: PCT/EP2016/057449

§ 371 Date: Oct. 24, 2017

(30) Foreign Application Priority Data
Apr. 24, 2015 (DE) 10 2015 106 307.7

(51) Int. Cl. H02G 1/06; B21F 7/00; F16G 13/16; H01B 13/012

(52) U.S. Cl. CPC H02G 1/06; H01B 13/01236; F16G 13/16; B21F 7/00

(57) ABSTRACT

The present invention relates to an apparatus for producing a power transmission chain with a cable set consisting of a line bundle of individual lines, with a receiving device with a receiving spindle for receiving a power chain, wherein the receiving spindle extends along an axis (A), and a carriage, which can be moved to and fro and has a clamping device for fixing the cable set, wherein the receiving device has at least one clamping device for fixing an end portion of the cable set, and the receiving spindle is mounted such that it can be rotated about its axis (A), wherein a fixing device for securing the line bundle is arranged between the receiving device and the carriage.

### RELATED APPLICATIONS

This application claims priority to German Patent Application No. 10 2015 106 307.7, filed on Apr. 24, 2015; and PCT/EP2016/057449, filed Apr. 5, 2016.

### FIELD

The invention relates to an apparatus and a method for producing a power chain or power transmission chain.

### BACKGROUND

Power transmission chains commonly also are referred to as power chains, e-chains or cable tracks, and represent flexible receiving devices for receiving one or more flexible cables or lines, pneumatic or hydraulic lines, and for moving the same along a defined axis of movement. The cables received by a power transmission chain typically are connected to a moving mechanical device to regularly—that is, constantly—move to and fro. Without such a guide, which ensures adherence to the smallest permissible bending radius of the cables, the cables would quickly be destroyed by the constant strain.

There are many different embodiments of power transmission chains. Most power transmission chains feature an essentially rectangular cross-section and consist of a multitude of individual elements connected via articulated joints. The cables are received on the inside. The cables typically are clamped at both ends with strain releases.

A general example of a power transmission chain is known from DE 102012106784 U. Furthermore, power transmission chains are known from the Japanese patent applications no. 2011-38545, no. 2007-247716 and no. 2007-92939, which include a specific structure for the reversible mounting of the cross member, that is, of the first or second cross member at the side plates of the side-plate rows, which are formed by the side plate-side connecting area on the side plate and the cross-member-side connecting area on the cross member, which engage with another. In such power transmission chains, it may occur that the cables constantly collide with the cross members, pushing the cross members outward, which may lead to operational disruptions.

Another problem that may occur is damage to the cables, in particular in configurations of a large number of individual cables with comparatively small cable diameters. It is possible for the cables to move into undesirable positions due to the constant movement, resulting in damage to the cables, even in cases in which cable-track-ready cables are specifically designed for frequent movement. Typically, these cables should feature several special characteristics compared to standard cables, such as resilience to movement, high flexibility and, ideally, a degree of torsional resilience that allows movements up to several million cycles. If normal cables were used, only a very limited number of cycles would be possible.

DE 202014101274 U1 also relates to the protection of the cables from damage caused by the energy transmission chains. Similarly, in DE 20 2009 005 605 U1, the protection of the cables is ensured through convex curving in peripheral direction of the surfaces of the top wall, bottom wall and, at a minimum, the transitional zones of these walls with the side walls. This, however, is primarily done for protection against external impacts, such as intruding foreign objects.

Unfortunately, it may occur in real-life applications that the cables or a cable loop migrate out of the cable track through side openings, which may result in damage to the cables up to the cables' being completely sheared off. The present invention relates to the object of preventing such cable damage that is not caused by external impacts such as foreign objects, but by the movement of the cables.

In the state of the art, DE 202014100540 U1, for example, relates to the prevention of cable breaks. In the worst-case scenario, a break leads to a rupture of one or more of the guided lines. That publication proposes a passive solution, by installing an appropriate monitoring system consisting of a detector—for example, a sensor, probe or similar device—that monitors whether the power transmission chain is properly functioning. Similar solutions are known from WO 2004/090375 A1 and/or WO 2013/156607 A1. Another monitoring system to protect against the rupture of lines is known from the international patent application WO 2009/095470 A1. In that application, a driver is connected to the power transmission chain via a coupling with a release, such that it automatically releases when a force limit is exceeded, initiating an emergency stop.

It is, however, disadvantageous to only detect cable breaks or imminent cable breaks. Rather, it is desirable to provide a power transmission chain in which individual cables cannot work their way out through openings and be sheared off by the cable track as a result of the movement. Another issue with the solutions known in the state of the art lies with the installation and durably secure retention of entire cable harnesses within the power transmission chain. In cable harnesses, the individual cables may become entangled, which can also lead to operational disruptions and problems.

### BRIEF SUMMARY

Proceeding from the state of the art, the object of the present invention therefore is to overcome the aforementioned disadvantages and to create a universal, cost-efficient solution for a power transmission chain, which features a high level of operational safety, can be produced simply and cost-efficiently, and which, in particular, guarantees secure and durable routing of the cables for many applications. Furthermore, the object of the present invention is to provide an apparatus and a method to produce such a power transmission chain.

This object is achieved through an apparatus with the features of claim 1, as well as through a method with the features of claim 7.

One basic principle of the present invention is to twist the line bundle of individual lines in an appropriate device prior to inserting the line bundle into the power transmission chain, such that the individual lines cannot move outward through openings in the power transmission chain during the subsequent motion of the same.

The present invention therefore provides an apparatus for producing a power transmission chain with a cable set consisting of a line bundle of individual lines, with a receiving device with a receiving spindle for receiving a power chain, wherein the receiving spindle extends along an axis A. The axis A thereby defines the extension direction of the spindle, as well as the preferable direction of the mechanical movement of the apparatus according to the invention. Furthermore, a carriage is included, which can be moved to and fro and which has a clamping device for fixing the cable set, wherein the receiving device comprises at least one clamping device for fixing an end portion of the cable set. In this manner, the cable set can be clamped into the receiving spindle such that the cable set is rotated by the spindle. In one preferred embodiment, the receiving spindle includes a clamping jaw on its end portion into which the front portion of the cable set, preferably covered with a protective sleeve, can be clamped.

The inventive apparatus is advantageous in that it includes a receiving spindle, which is mounted such that it can be rotated about its axis A, so that a power chain slid onto the receiving spindle can be rotated around the axis A along with the spindle. Alternatively, the other end, or an opposing section, could also be rotated. Likewise, it is conceivable that the two ends of the cable set are rotated in opposite directions.

It is advantageous for a fixing device for securing (or locking) the line bundle of the cable harness to be arranged between the receiving device and the carriage. It is particularly preferable for the fixing device to be movable to a desired position related to the necessary cable length, such that, for example, one-half of a lay length is maintained to the left and right of the fixing device when twisting the line bundle.

One advantageous embodiment of the invention therefore includes a rotational drive to rotate the receiving spindle, wherein the drive preferably is connected to the spindle in such a way that it can rotate the receiving spindle about its central axis (that is, about the longitudinal axis A). To perform a rotation on the other side of the cable loom, a corresponding rotational drive must be arranged in a suitable position to perform the desired twisting.

It is advantageous to design the apparatus such that the carriage can be moved to and fro in the axial direction A, or that it can be moved to and fro in such a manner that the carriage moves by the distance necessary to compensate for the difference in length of the line bundle that results from its being twisted.

In one particularly advantageous embodiment of the invention, a ring element is included as the fixing device to fix the line bundle so that it can be twisted, wherein the ring element is equipped with two openings to receive a multitude of individual lines of the line bundle. The ring element furthermore preferably can be actuated from a closed position into an open position and vice versa to insert a line bundle into the openings or, respectively, to withdraw the same from them. In this manner, for example, the first half of the multitude of lines of the line bundle could be guided through one opening and the second half of the multitude of lines of the line bundle through the second opening. The fixing element does not necessarily have to be designed as a ring element. It is also possible to use a simple pin as a locking bar without a ring. If this is the case, no partial openings exist, instead, a pin is included that penetrates the line bundle. Additionally, a multitude of openings also are conceivable if the locking bar is designed accordingly.

In the embodiment with the ring element, the element comprises a locking bar that separates the opening in the ring element into the two partial openings, so that a portion of the lines of the line bundle can be received in each of the two partial openings (for example, half in each partial opening).

A further aspect of the present invention relates to a method for producing a power transmission chain. The present invention provides for producing a power transmission chain with a cable set consisting of a line bundle of individual lines, preferably with an apparatus as described previously, via the following steps:

a. Mounting a power chain onto the receiving spindle of the receiving device;

b. fixing an end portion of a cable set consisting of a line bundle of a multitude of individual lines in the clamping device of the receiving spindle;

c. fixing the cable set in the clamping device of the carriage at a section a distance away from the end portion;

d. inserting the line bundle into the fixing device;

e. rotating the receiving spindle together with the power chain about the axis A to twist the line bundle; and

f. sliding the power chain over the twisted section of the line bundle.

Alternatively, a rotating relative movement between the power transmission chain and the fixing device could also be achieved by rotating the locking bar of the fixing device relative to the clamped sections of the cable set. For example, a ring element, which can be freely positioned, is rotationally driven via spur gears, and which includes an interior locking bar, can be rotated in such a way as to result in the desired lay lengths of the stranded cable set to the left and the right of the locking bar.

The present invention preferably provides for sliding the entire power chain over the line bundle subsequently to the stranding of the line bundle, such that the end portion of the cable set protrudes from the respective other end of the power chain.

In one preferred embodiment of the inventive method, the carriage is moved during the twisting of the line bundle—for example, during the aforementioned step e)—by the distance necessary to compensate for the difference in length of the line bundle that results from its being twisted. To achieve this, a controller could be provided, which captures the difference in length or a measurement related to it (for example, rotational angle) via sensors. Furthermore, the carriage can only be moved once a defined force threshold has been exceeded, so that the clamped cable harness can always be kept at a desired tension during the stranding process.

### BRIEF DESCRIPTION OF THE DRAWINGS

Other advantageous embodiments of the invention are characterized in the dependent claims and/or are explained in more detail below in the description of the preferred embodiment of the invention with reference to the figures.

### Wherein:

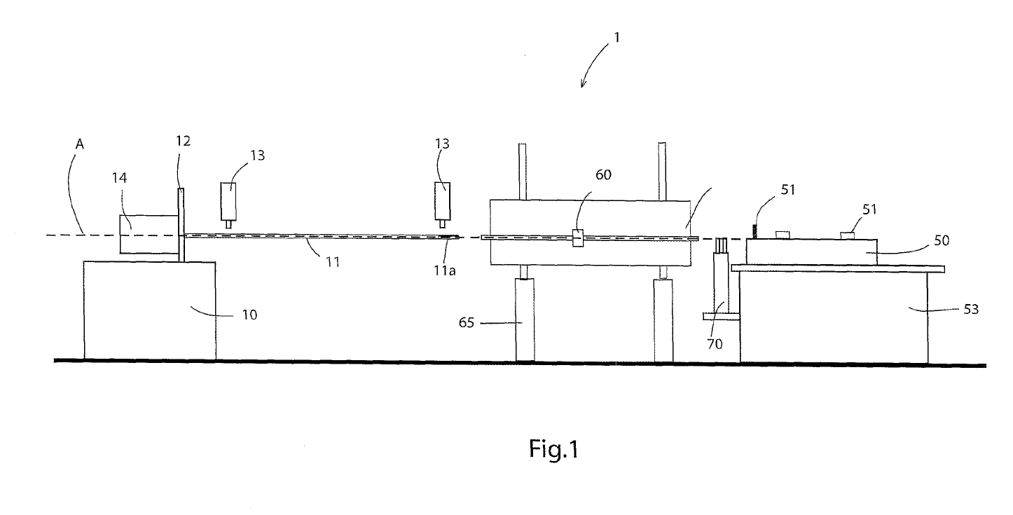

FIG. 1 an exemplary embodiment of an apparatus according to the invention for producing a power transmission chain;

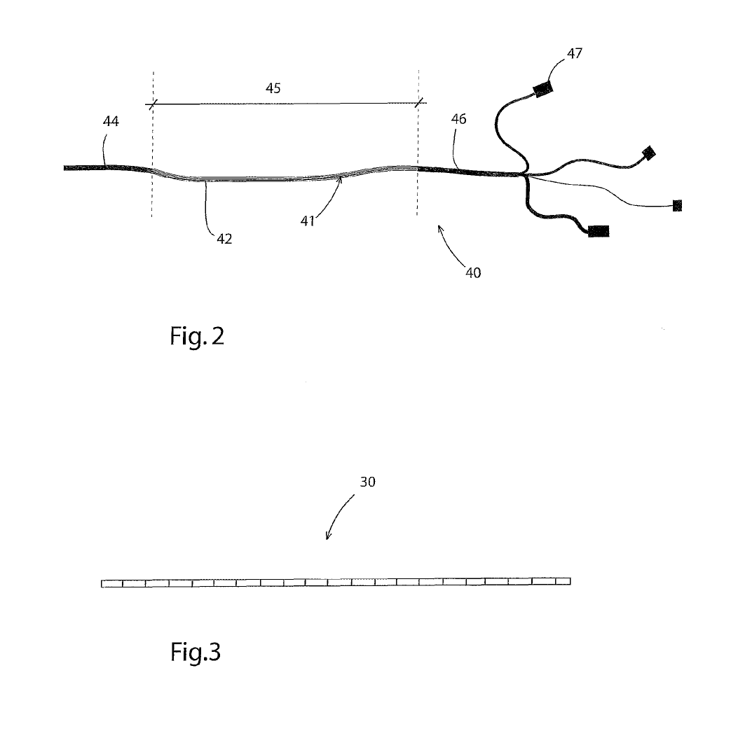

FIG. 2 an exemplary representation of a cable set with connectors attached to the end portions;

FIG. 3 an exemplary representation of a power transmission chain for use in production with the apparatus according to FIG. 1;

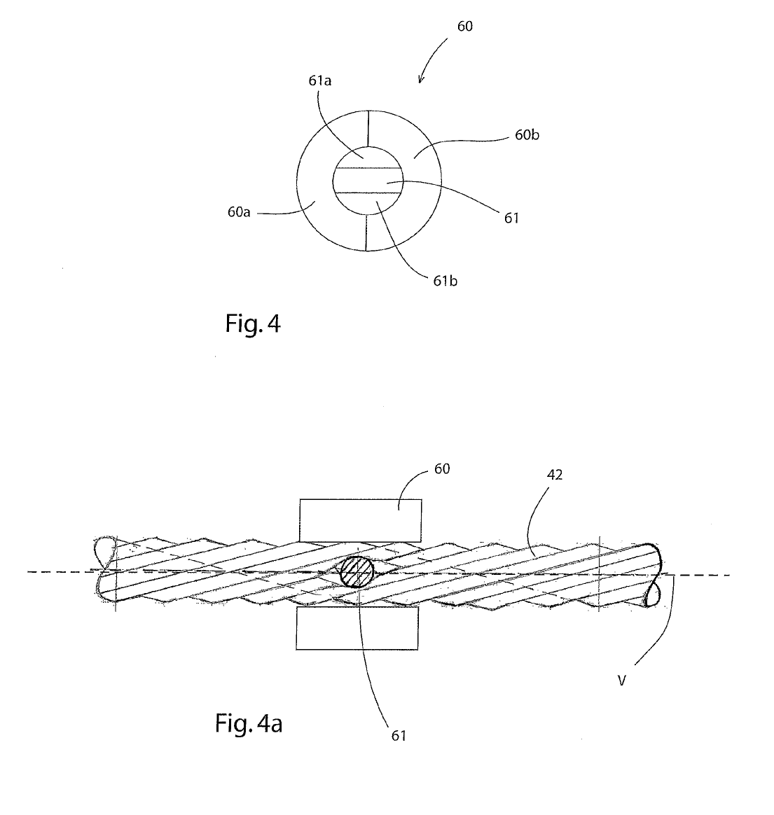

FIG. 4 an exemplary embodiment of a fixing device designed as a ring-shaped locking bar;

FIG. 4a the fixing device from FIG. 4, which engages with the line bundle of the cable set from FIG. 2 via its locking bar; and

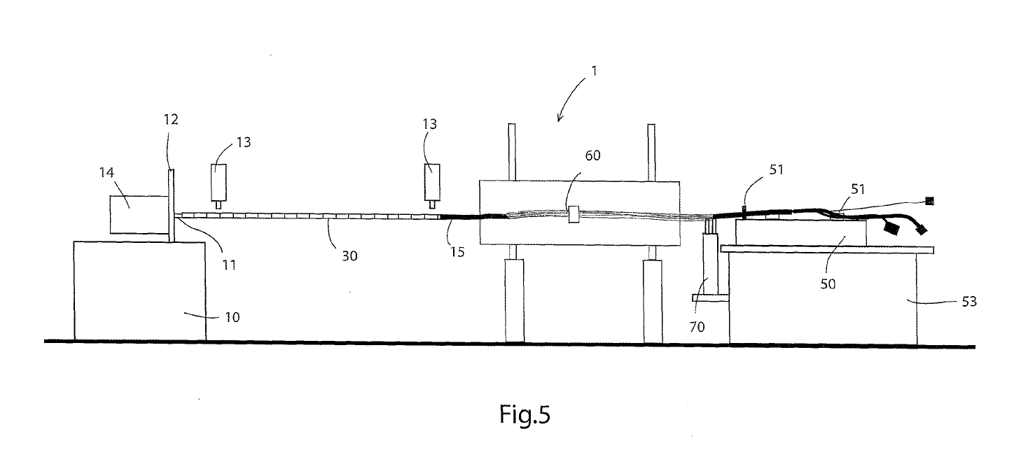

FIG. 5 the exemplary embodiment according to FIG. 1 with a mounted cable set from FIG. 2 and a power transmission chain according to FIG. 3.

### DETAILED DESCRIPTION

The invention is described in more detail in the following sections, using an exemplary and diagrammed embodiment with reference to FIGS. 1 to 5. Identical reference symbols in the figures indicate identical or similar functional or structural characteristics.

FIG. 1 shows an apparatus 1 for producing a power transmission chain 30 with a cable set 40 consisting of a line bundle 41 of individual lines 42 (as explained in more detail in FIG. 2). Apparatus 1 comprises a receiving device 10 to receive the power transmission chain 30. For this purpose, the receiving device 10 is equipped with a receiving spindle 11, which is mounted on a bracket 12 of the receiving device 10 such that it can rotate.

The rotating receiving spindle 11 comprises a rotational and longitudinal axis A, and the free end of the spindle extends in the direction of the longitudinal axis A such that it can receive a power transmission chain 30.

Furthermore, the apparatus 1 comprises a carriage 50, which can move to and fro on a bearing device 53. The carriage 50 is equipped with a clamping device 51 for fixing the cable set 40, as seen in the example shown in FIG. 2. The cable set 40 consists of a line bundle 41 of insulated individual lines 42. Other combinations of lines combined in a cable set also are conceivable, insofar as these can be stranded. In the present exemplary embodiment, an end portion 44 of the line bundle 41 is wrapped with tape. This is followed by a section 45, in which the individual lines are freely accessible. This section 45 is followed by a further section 46, which also is wrapped with tape in the present example. At the ends of the lines, connectors 47 are attached to the lines as an example, or the ends could be equipped with contact terminals.

The carriage 50, which can move to and fro, is arranged to move in the direction of axis A such that it moves, or can be moved, during the twisting of the line bundle 41 (which will be described in more detail in the following) by the distance that is necessary to compensate for the difference in length of the line bundle 41 that results from its being twisted. The effective line bundle length naturally decreases while the bundle is progressively twisted during the stranding process, that is, with decreasing lay length. To accommodate this circumstance, the clamping device 51 for the cable set 40 is movable with the carriage 50. Further brackets 52 are provided to secure the cable set 40 or its wiring harnesses to the carriage. A movable arrangement of the bracket itself also is conceivable to compensate for the difference in length.

The receiving device 10 furthermore includes a clamping device 15 for fixing the end portion 44 of the cable set 40. The clamping device 15 protrudes into the box-shaped receiving space of the receiving spindle 11. Cable set 40 can be clamped and fixed to a defined position with this device. The receiving spindle 11 is designed as a spindle with a rectangular cross-section in the present example, and its cross-section shape corresponds to the cross-section of the opening and the shape of the power transmission chain 30, which is to be produced. Therefore, when the power transmission chain 30 is slid onto the receiving spindle 11, it can only rotate together with the spindle about its axis A.

As can be seen in FIGS. 1 and 5, a fixing device 60 is located between the receiving device 10 and the carriage 50, which is arranged to lock the line bundle 41 into a position approximately in the extension of the axis A. The fixing device 60 and its mode of operation are shown in more detail in FIGS. 4 and 4a. The exemplary embodiment of the fixing device 60 is designed as a ring-shaped spindle device consisting of two half-shells, 60a and 60b, which are connected to each other in a detachable manner. The ring element 60, which is designed as a fixing device, comprises a spindle 61, which extends from approximately the center of one interior wall to the opposite interior wall, and which separates the originally cylinder-shaped opening of the ring element 60 into two partial openings, 61a and 61b, for receiving the line bundle 41. By rotating the ring element and thereby rotating the line bundle 41 relative to the spindle 61 about the stranding axis V shown in FIG. 4b, the individual lines 42 of the line bundle 41 are twisted around each other. If the spindle 61 is inserted into the line bundle 41 in a position approximately centered on the two clamping devices 15 and 51, and if the previously opened ring element is then closed again, a lay length of approximately 50% of the twisted length is achieved, as in the example shown in FIG. 4b.

As described previously, the ring element 60 can be actuated from a closed position into an open position and vice versa to insert or withdraw a line bundle 41. It is preferred that the spindle 61 slides between the walls of the ring element 60 so far as to give the spindle 61 sufficient stability.

FIG. 5 shows the use of the apparatus in a representation of its basic principles. As previously explained, the rotational drive 14 is connected with the receiving spindle 11 in such a way that it rotates the receiving spindle 11 about its axis A and thereby performs the desired stranding.

This process is executed as follows. First, a power chain 30 is mounted to the receiving spindle 11 of the receiving device 10 by sliding it onto the spindle.

Then the end portion 44 of a cable set 40, consisting of a line bundle 41 of a multitude of individual lines 42, which is to be mounted, is clamped into the clamping device 15 of the receiving spindle 11.

Furthermore, the cable set 40 is locked into the clamping device 51 of the carriage 50 at its section 46, as diagrammed in FIG. 5. Then, the individual lines 42 of the line bundle 41 are inserted into the previously opened fixing device 60 such that the spindle separates the line bundle 41 into two partial bundles (see FIG. 4b).

Rotating the receiving spindle 11 relative to the spindle 61 results in the twisting of the line bundle 41. After the stranding process has been completed, the power chain 30 is slid over the twisted section of the line bundle 41 until the end portion 44 of the line bundle 41 emerges from the respective other end of the power chain 30, or until it reaches a position that can be captured by the sensors 13. Furthermore, additional sensors 13 can be provided to monitor other cable positions and/or to capture their correct position. After cable set 40 is mounted in the power chain 30, its position is locked with suitable fixing devices. In one cost-efficient variant, this fixing process is performed via cable ties to the power chain.

Furthermore, a splitting device 70 for splitting a cable set or parts thereof can be provided on the apparatus 1.

The invention is not limited in its embodiments to the preferred exemplary embodiments listed above. Rather, a multitude of variants is conceivable which make use of the represented solution, even in embodiments of fundamentally different types.

1. An apparatus for producing a power transmission chain with a cable set consisting of a line bundle of individual lines, with a receiving device with a receiving spindle for receiving a power chain, wherein the receiving spindle extends along an axis (A), and a carriage, which can be moved to and fro and has a clamping device for fixing the cable set, wherein the receiving device has at least one clamping device for fixing an end portion of the cable set, and the receiving spindle is mounted such that it can be rotated about its axis (A), wherein a fixing device for securing the line bundle is arranged between the receiving device and the carriage.

2. The apparatus according to claim 1, wherein a rotational drive is connected with the receiving spindle in such a way that it can rotate the receiving spindle about its axis (A).

3. The apparatus according to claim 1, wherein the carriage is arranged in such a way that it can be moved to and fro in the direction of the axis (A).

4. The apparatus according to claim 1, wherein the fixing device is provided as a ring element with at least one opening, but preferably two openings (61a, 61b), for receiving the line bundle.

5. The apparatus according to claim 4, wherein the ring element can be actuated from a closed position into an open position and vice versa, to insert a line bundle or, respectively, to withdraw the same.

6. The apparatus according to claim 4, wherein the ring element comprises a locking bar, which separates the opening in the ring element into two partial openings (61a, 61b), so that a portion of the lines of the line bundle can be received in each of the two partial openings (61a, 61b).

7. A method for producing a power transmission chain with a cable set consisting of a line bundle of individual lines, using an apparatus according to claim 1, comprising the following steps:
a. mounting a power chain onto the receiving spindle of the receiving device;
b. fixing an end portion of a cable set consisting of a line bundle of a multitude of individual lines in the clamping device of the receiving spindle;
c. fixing the cable set in the clamping device of the carriage at a section a distance away from the end portion;
d. inserting the line bundle into the fixing device (60);
e. rotating the receiving spindle together with the power chain about the axis (A) to twist the line bundle; and
f. sliding the power chain over the twisted section of the line bundle.

8. The method according to claim 7, wherein the entire power chain is slid over the line bundle and that the end portion protrudes from the respective other end of the power chain.

9. The method according to claim 7, wherein the carriage is moved during the twisting of the line bundle in step e) by the distance necessary to compensate for the difference in length of the line bundle that results from its being twisted.

10. The method according to claim 7, wherein a ring element with an opening is used as the fixing device, which is equipped with a locking bar penetrating the opening, which separates the opening in the ring element into two partial openings (61a, 61b), wherein a first portion of the lines of the line bundle is received in the first of the two partial openings (61a, 61b) and a second portion of the lines of the line bundle in the second.
